(19) United States
(12) Patent Application Publication
(10) Pub. No.: US 2016/0202408 A1
(43) Pub. Date: Jul. 14, 2016

(54) DISPLAY MODULE WITH OPTICALLY FUNCTIONAL FILM AND METHOD OF MANUFACTURING THEREOF

(71) Applicants: RAYMOND WANG, TAICHUNG CITY (TW); RAYSHINE PHOTONICS CORP., TAICHUNG CITY (TW)

(72) Inventor: RAYMOND WANG, TAICHUNG CITY (TW)

(21) Appl. No.: 14/851,578

(22) Filed: Sep. 11, 2015

(30) Foreign Application Priority Data
Jan. 13, 2015 (TW) 104101062

(51) Int. Cl. F21V 8/00

(52) U.S. Cl. CPC G02B 6/0053; G02B 6/0055; G02B 6/0056

(57) ABSTRACT

A display module with an optically functional film includes two polarizers, a display panel, an optically functional film, a lighting component, a light guide plate, and a reflector. The optically functional film includes a first transformation layer, a second transformation layer, a diffusion layer, a brightness enhancement layer, and a polarized layer, and each layer of the optically functional film is attached to each other by transfer-coating. Therefore, the thickness of the optically functional film of the present invention can be reduced, so that the cost of manufacturing the display module with the optically functional film is lowered and the volume of the display module is reduced without reducing brightness.

### FIELD OF THE INVENTION

The present invention relates to a display module, particularly, relates to a display module with optically functional film and method of manufacturing thereof.

### BACKGROUND OF THE INVENTION

Present liquid crystal display has been broadly applied to a portable display, a desktop display and a vehicle display. The portable display may be one of a mobile phone, a camera, and a panel computer. The desktop display may be the one of a television, a desktop computer, and a laptop computer. The vehicle display may be one of a satellite navigator, an automobile instrument panel, and a data recorder. The liquid crystal display is required to have light volume for easy portability and arrangement, and it is also a key issue to reduce the volume of liquid crystal display.

Besides, for display module, a backlight module includes a lighting component, light guide plate, optical conversion film, diffusion film, and brightness enhancement film. The optical conversion film, the diffusion film, and the brightness enhancement film are generally individual optical components. Thus, in assembly of these optical components, the matching of these optical components should be considered for maximizing the optical characteristics of these optical components. Thus, air gaps are existed among these optical components. However, such a structure with air gaps increases the whole thickness of the liquid crystal display. Moreover, the existence of air gaps results in the intensity loss of light because light scattering and reflection in the air gaps, as well as the brightness reduction of liquid crystal display. Consequently, reducing the whole thickness of these optical components after assembly without reducing brightness of the display should be solved.

### SUMMARY OF THE INVENTION

Accordingly, the present invention provides a display module with an optically functional film. The compositions of the optically functional film, which includes a first conversion layer, a second conversion layer, a brightness enhancement layer, a diffusion layer, and a polarization layer, are integrated together by print-on coating and matching of index of refraction. Hence, the thickness of the optically functional film and the whole volume of the display module with the optically functional film are both reduced without lowering the brightness of the display module.

Accordingly, a display module with an optically functional film includes an upper polarizer, a lower polarizer, a display panel, a lighting component, a light guide plate, and a reflection plate. The upper polarizer and the lower polarizer are respectively attached over an upper surface and a bottom surface of the display panel. The light guide plate is deposited upon the reflection plate, the lighting component is set to one side of the light guide plate and one side of the reflection plate, the lighting component emits point light to the reflection plate, and the reflection plate reflects the point light to the light guide plate. The light guide plate receives the point light and outputs the point light to the optically functional film after guiding the propagation direction of point light. The display module is characterized in which the display module with an optically functional film comprises the optically functional film, a bottom surface of the optically functional film is deposited on the light guide plate, an upper surface of the optically functional film is deposited on a bottom surface of the lower polarizer, and a thickness of the optically functional film is from 0.4 mm to 1.4 mm. The optically functional film comprises a first conversion layer, a second conversion layer, and a diffusion layer, the first conversion layer comprises an upper surface which shows a prism structure and a flat bottom surface, the first conversion layer converts the guided point light outputted from the light guide plate into a linear light, the second conversion layer comprises an upper surface which shows a prism structure and a flat bottom surface, the second conversion layer is deposited onto the first conversion layer, and the second conversion layer converts the linear light outputted from the first conversion layer into surface light and outputs the surface light to the diffusion layer. The diffusion layer comprises a flat upper surface and a flat bottom surface, the diffusion layer is deposited onto the second conversion layer, and the diffusion layer uniforms the surface light outputted from the second conversion layer.

Accordingly, a manufacturing method of an optically functional film, in which a bottom surface of the optically functional film is deposited on a light guide plate of a display module, an upper surface of the optically functional film is deposited on a bottom surface of a lower polarizer of the display module. The manufacturing method includes providing a first conversion layer having an upper surface with a prism angle in the range of 40 to 140 degrees and a flat bottom surface, and the first conversion layer converts point light into linear light, providing a second conversion layer having an upper surface with a prism angle in the range of 40 to 140 degrees and a flat bottom surface, and the second conversion layer converts the linear light outputted from the first conversion layer into surface light, depositing the second conversion layer on the first conversion layer by print-on coating process, the edge of upper surface of the first conversion layer is attached to the edge of the bottom surface of the second conversion layer for forming an air gap between the upper surface of the first conversion layer and the bottom surface of the second conversion layer, providing a diffusion layer having a flat upper surface and a flat bottom surface, the diffusion layer uniforms the surface light outputted from the second conversion layer, and depositing the diffusion layer onto the second conversion layer by print-on coating process, and the edge of the upper surface of the second conversion layer is attached to the edge of the bottom surface of the diffusion layer for forming an air gap between the upper surface of the second conversion layer and the bottom surface of the diffusion layer.

The present invention provides a display module with an optically functional film and the manufacturing method thereof. The components of the optically functional film, which include a first conversion layer, a second conversion layer, a brightness enhancement layer, a diffusion layer, and a polarization layer, are integrated together by print-on coating and matching of index of refraction. Hence, the thickness of the optically functional film and the whole volume of the display module with such the optically functional film are both reduced without reducing the brightness of the display module.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic diagram illustrating a display module of the present invention.

FIG. 2 is a schematically side-view diagram illustrating the first embodiment of display module of the present invention.

FIG. 3 is a schematically diagram illustrating the first and the second conversion layers of an optically functional film of the present invention.

FIG. 4 is a schematically side-view diagram illustrating the second embodiment of display module of the present invention.

FIG. 5 is a schematically side-view diagram illustrating the third embodiment of display module of the present invention.

FIG. 6 is a schematically side-view diagram illustrating the fourth embodiment of display module of the present invention.

FIG. 7 is a schematically side-view diagram illustrating the fifth embodiment of display module of the present invention.

FIG. 8 is a schematically side-view diagram illustrating the sixth embodiment of display module of the present invention.

FIG. 9 is a schematically diagram illustrating a manufacturing steps of an optically functional film in the first and the third embodiment of the present invention.

FIG. 10 is a schematically diagram illustrating a manufacturing of an optically functional film in the second and the fourth embodiment according to the present invention.

FIG. 11 is a schematically diagram illustrating a manufacturing method of an optically functional film in fifth embodiment of the present invention.

FIG. 12 is a schematically diagram illustrating a manufacturing method of an optically functional film in the sixth embodiment of the present invention.

### DETAILED DESCRIPTION OF THE PREFERRED EMBODIMENT

The lighting principle of the lighting component and the display techniques in the present invention is well known by a person in the art. The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

The present invention relates to a display module with optically functional film and manufacturing method thereof, and especially relates to the display module which includes an upper polarizer, a lower polarizer, a display panel, an optically functional film, a light guide plate, a reflection plate and a lighting component and the manufacturing method.

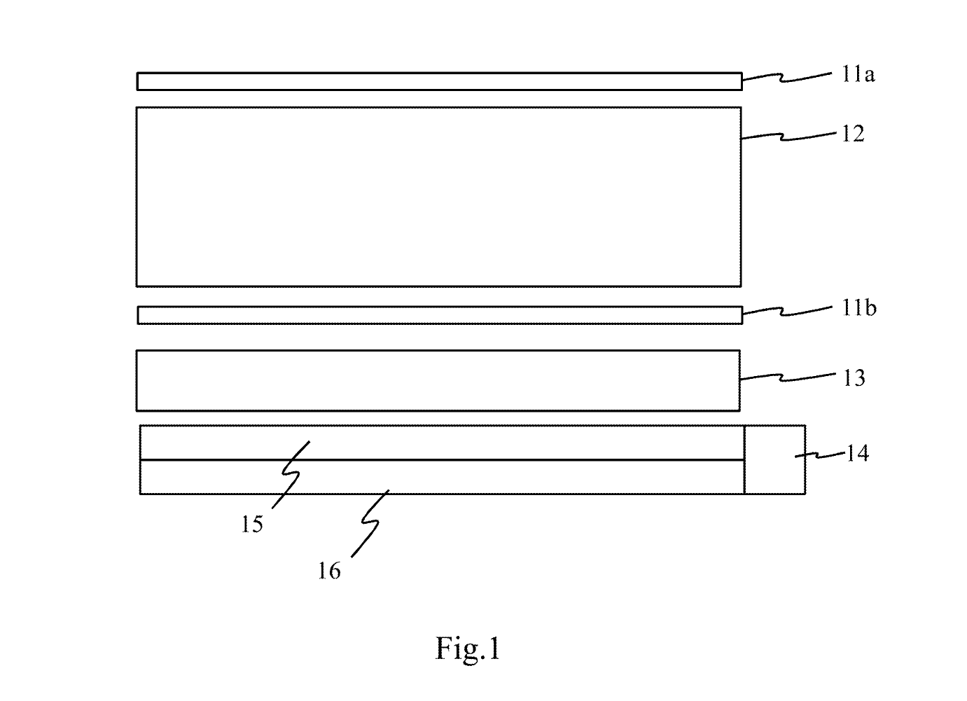

FIG. 1 is a schematic diagram illustrating a display module of the present invention.

As shown in FIG. 1, the display module of the present invention includes an upper polarizer 11a, a lower polarizer 11b, a display panel 12, an optically functional film 13, a lighting component 14, a light guide plate 15, and a reflection plate 16. The upper polarizer 11a and the lower polarizer 11b are respectively attached over the upper surface and the bottom surface of the display panel 12. The light guide plate 15 is deposited upon the reflection plate 16, and the lighting component 14 is set to one side of the light guide plate 15 and one side of the reflection plate 16. The bottom surface of the optically functional film 13 is attached or deposited on the light guide plate 15, and the upper surface of the optically functional film 13 is attached or deposited on the bottom surface of the lower polarizer 11b. The lighting component 14 emits point light to the reflection plate 16, and the reflection plate 16 reflects the point light to the light guide plate 15. The light guide plate 15 guides the propagation direction of the reflected point light and outputs the reflected point light to the optically functional film 13, and the optically functional film 13 converts the guided point light into surface light. The optically functional film 13 outputs the surface light to the lower polarizer 11b for polarizing the surface light. The polarized surface light is outputted to the display panel 12 for displaying images, and the upper polarizer 11a polarizes the images shown by the display panel 12.

The point light described herein and after mentioned is equivalent to light emitted from a point light source. Similarly, the surface light described herein and after mentioned is equivalent to light emitted from a surface light source, and linear light described herein and after mentioned is equivalent to light emitted from a line light source.

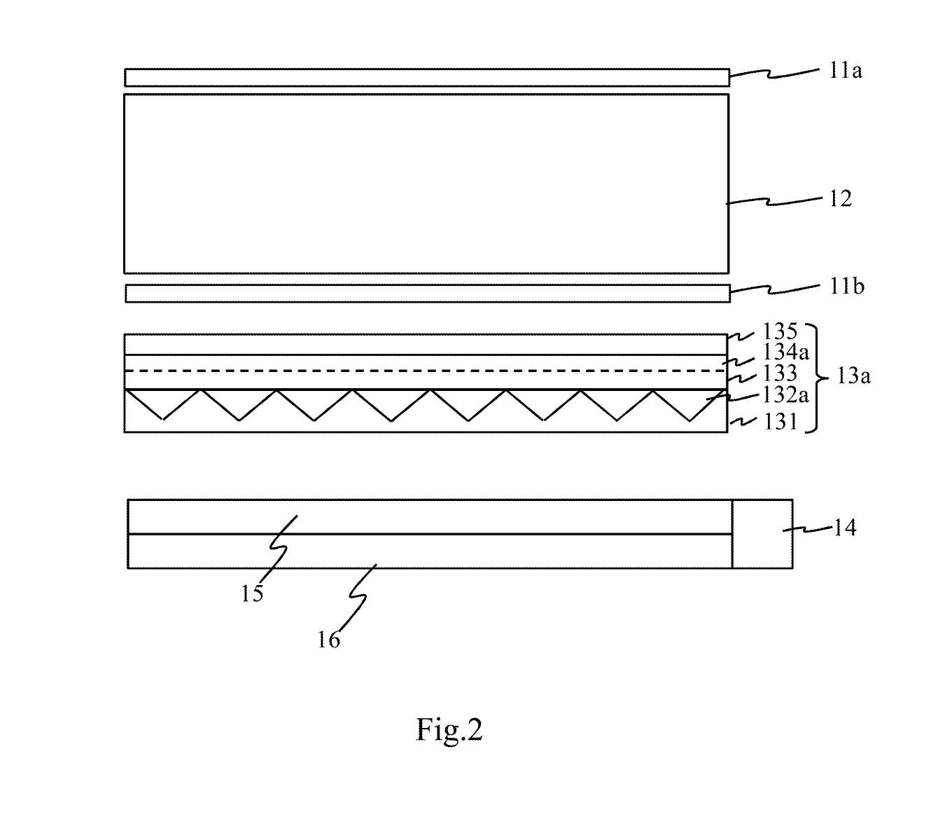

Next, FIG. 2 is a schematically side-view diagram illustrating the first embodiment of display module of the present invention.

As shown in FIG. 2, the display module of the present invention includes the upper polarizer 11a, the lower polarizer 11b, the display panel 12, an optically functional film 13a, the lighting component 14, a light guide plate 15, and a reflection plate 16. The upper polarizer 11a is attached on the upper surface of the display panel 12. The light guide plate 15 is deposited on the reflection plate 16, and the lighting component 14 is set to one side of the light guide plate 15 and one side of the reflection plate 16. The bottom surface of the optically functional film 13a is attached or deposited on the light guide plate 15, and the upper surface of the optically functional film 13a is attached or deposited on the bottom surface of the lower polarizer 11b. The upper surface of the lower polarizer 11b is attached on the bottom surface of the display panel 12. The lighting component 14 emits point light to the reflection plate 16, and the reflection plate 16 reflects the point light to the light guide plate 15. The light guide plate 15 guides the propagation direction of the reflected point light and outputs the reflected point light to the optically functional film 13a, and the optically functional film 13a converts the guided point light into linear light, converts the linear light into surface light and uniforms the surface light sequentially. The optically functional film 13a outputs the uniform surface light to the lower polarizer 11b for polarizing the surface light. The polarized surface light is outputted to the display panel 12 for displaying images, and the upper polarizer 11a polarizes the images shown by the display panel 12.

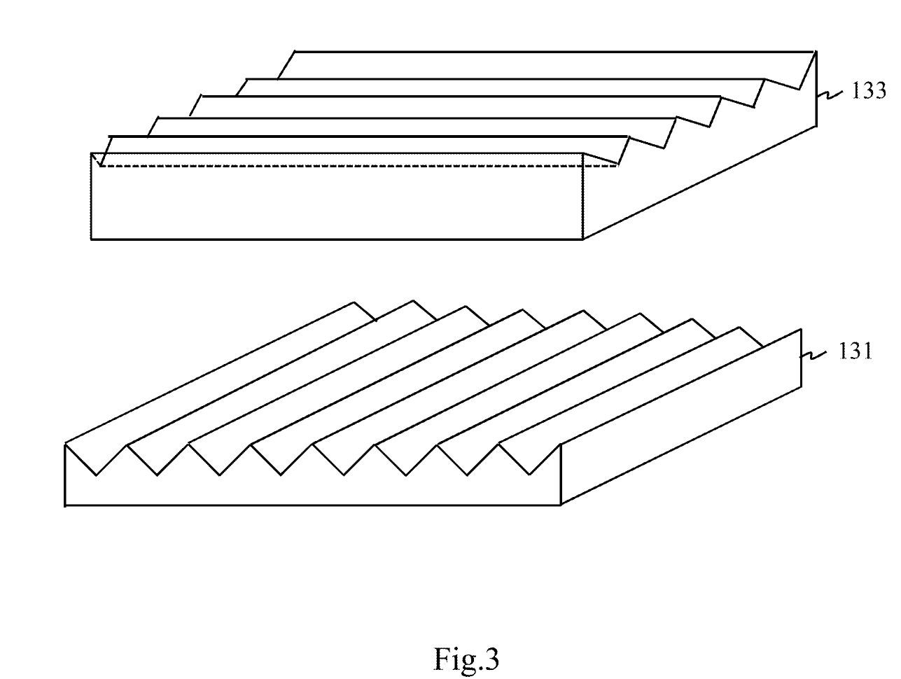

Please still refer to FIG. 2. The optically functional film 13a includes a first conversion layer 131, a second conversion layer 133 and a diffusion layer 135. The first conversion layer 131 has an upper surface and a bottom surface and the second conversion layer 133 has an upper surface and a bottom surface. The diffusion layer 135 includes a flat upper surface and a flat bottom surface. The upper surfaces of the first conversion layer 131 and the second conversion layer 133 are both a prism structure (shown in FIG. 3) with a prism angle in the range of 40 to 140 degrees. The edge of the upper surface of the first conversion layer 131 and the edge of the flat bottom surface of the second conversion layer 133 are attached by print-on coating process, and an air gap 132a is formed between the upper surface of the first conversion layer 131 and the flat bottom surface of the second conversion layer 133. The edge of the flat bottom surface of the diffusion layer 135 and the edge of the upper surface of the second conversion layer 133 are attached each other by print-on coating process, and an air gap 134a is formed between the flat bottom surface of the diffusion layer 135 and the upper surface of the second conversion layer 133. The upper surface of the diffusion layer 135 is attached or deposited on the bottom surface of the lower polarizer 11b. The first conversion layer 131 converts the point light emitted from the lighting component 14 into linear light, and the second conversion layer 133 converts the linear light outputted from the first conversion layer 131 into surface light and outputs the surface light to the diffusion layer 135. The diffusion layer 135 receives and uniforms the surface light to make the surface light more uniform. The diffusion layer 135 outputs the uniform surface light to the lower polarizer 11b, and the lower polarizer 11b polarizes the surface light outputted from the diffusion layer 135. The polarized surface light is outputted to the display panel 12 for displaying images, and the upper polarizer 11a polarizes the image displayed by the display panel 12.

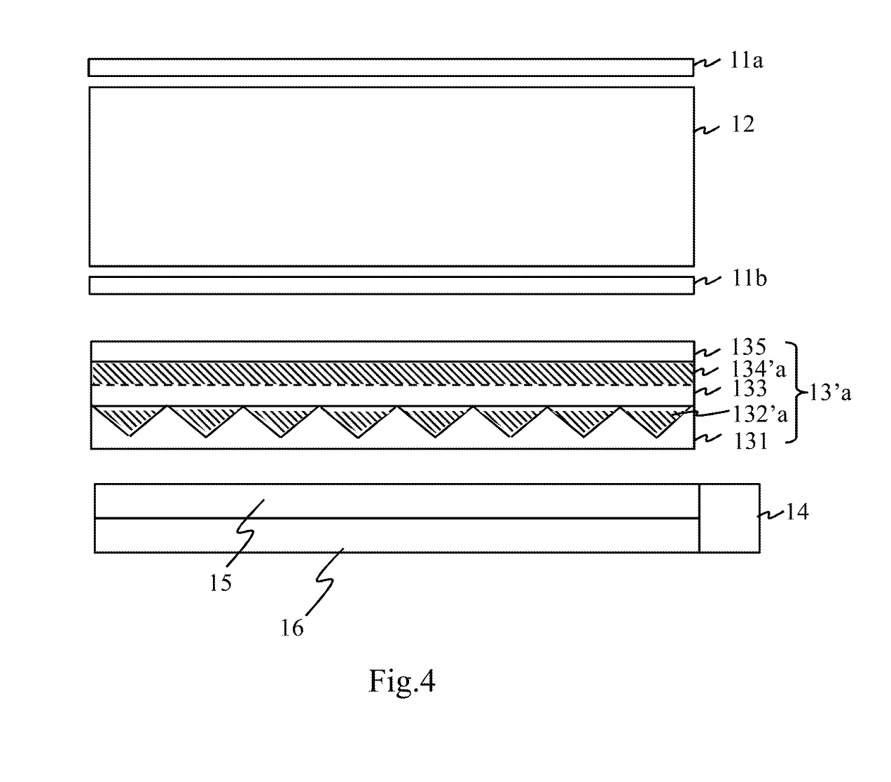

Next, FIG. 4 is a schematically side-view diagram illustrating the second embodiment of display module of the present invention.

As shown in FIG. 4, the display module of the present invention includes the upper polarizer 11a, the lower polarizer 11b, the display panel 12, an optically functional film 13′a, the lighting component 14, a light guide plate 15, and a reflection plate 16. The upper polarizer 11a is attached to the upper surface of the display panel 12. The light guide plate 15 is deposited on the reflection plate 16, and the lighting component 14 is set to one side of the light guide plate 15 and one side of the reflection plate 16. The bottom surface of the optically functional film 13′a is attached or deposited on the light guide plate 15, and the upper surface of the optically functional film 13′a is attached or deposited on the bottom surface of the lower polarizer 11b. The upper surface of the lower polarizer 11b is attached upon the bottom surface of the display panel 12. The lighting component 14 emits point light to the reflection plate 16, and the reflection plate 16 reflects the point light to the light guide plate 15. The light guide plate 15 guides the propagation direction of the reflected point light and outputs the reflected point light to the optically functional film 13′a, and the optically functional film 13′a converts the guided point light into linear light, converts the linear light into surface light and uniforms the surface light. The optically functional film 13′a outputs the uniform surface light to the lower polarizer 11b for polarizing the surface light. The polarized surface light is outputted to the display panel 12 for displaying images, and the upper polarizer 11a polarizes the images shown by the display panel 12.

Please still refer to FIG. 4. The optically functional film 13′a includes a first conversion layer 131, a second conversion layer 133 and a diffusion layer 135. The first conversion layer 131 has an upper surface and a bottom surface and the second conversion layer 133 has an upper surface and a bottom surface. The diffusion layer 135 includes a flat upper surface and a flat bottom surface. The upper surfaces of the first conversion layer 131 and the second conversion layer 133 are both a prism structure (shown in FIG. 3) with a prism angle in the range of 40 to 140 degrees. An air gap between the upper surface of the first conversion layer 131 and the bottom surface of the second conversion layer 133 is filled with optical cement 132′a. That is, the upper surface of the first conversion layer 131 and the flat bottom surface of the second conversion layer 133 are attached each other with the optical cement 132′a by the pint-on coating without air gap. The flat bottom surface of the diffusion layer 135 and the upper surface of the second conversion layer 133 are attached each other with the optical cement 134′a by the print-on coating without air gap. The upper surface of the diffusion layer 135 is attached or deposited on the bottom surface of the lower polarizer 11b. The first conversion layer 131 converts the point light emitted from the lighting component 14 into linear light, and the second conversion layer 133 converts the linear light outputted from the first conversion layer 131 into surface light and outputs the surface light to the diffusion layer 135. The diffusion layer 135 receives and uniforms the surface light outputted from the second conversion layer 133 to make the surface light more uniform. The diffusion layer 135 outputs the uniform surface light to the lower polarizer 11b, and the lower polarizer 11b polarizes the surface light outputted from the diffusion layer 135. The polarized surface light is outputted to the display panel 12 for displaying images, and the upper polarizer 11a polarizes the images shown by the display panel 12.

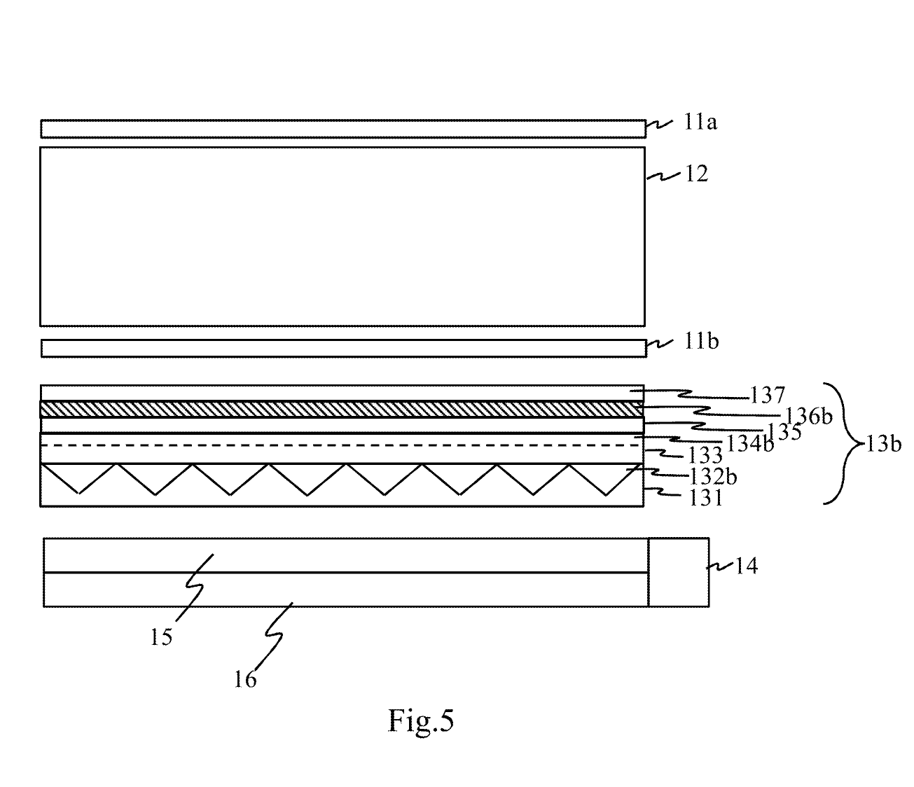

Next, FIG. 5 is a schematically side-view diagram illustrating the third embodiment of display module of the present invention.

As shown in FIG. 5, the display module of the present invention includes the upper polarizer 11a, the lower polarizer 11b, the display panel 12, an optically functional film 13b, the lighting component 14, a light guide plate 15, and a reflection plate 16. The upper polarizer 11a is attached on the upper surface of the display panel 12. The light guide plate 15 is deposited on the reflection plate 16, and the lighting component 14 is set to one side of the light guide plate 15 and one side of the reflection plate 16. The bottom surface of the optically functional film 13b is attached or deposited upon the light guide plate 15, and the upper surface of the optically functional film 13b is attached or deposited on the bottom surface of the lower polarizer 11b. The upper surface of the lower polarizer 11b is attached on the bottom surface of the display panel 12. The lighting component 14 emits point light to the reflection plate 16, and the reflection plate 16 reflects the point light to the light guide plate 15. The light guide plate 15 guides the propagation direction of the reflected point light and outputs the reflected point light to the optically functional film 13b. The optically functional film 13b converts the guided point light into linear light, converts the linear light into surface light, uniforms the surface light, enhances the brightness of the surface light, and outputs the uniform surface light to the lower polarizer 11b for polarizing the surface light. The polarized surface light is outputted to the display panel 12 for displaying images, and the upper polarizer 11a polarizes the images shown by the display panel 12.

Please still refer to FIG. 5. The optically functional film 13b includes a first conversion layer 131, a second conversion layer 133, a diffusion layer 135 and a brightness enhancement layer 137. The first conversion layer 131 has an upper surface and a bottom surface and the second conversion layer 133 has an upper surface and a bottom surface. The diffusion layer 135 has a flat upper surface and a flat bottom surface. The brightness enhancement layer 137 has a flat upper surface and a flat bottom surface. The upper surfaces of the first conversion layer 131 and the second conversion layer 133 are both a prism structure (shown in FIG. 3) with a prism angle in the range of 40 to 140 degrees. The edge of the upper surface of the first conversion layer 131 and the edge of the flat bottom surface of the second conversion layer 133 are attached by print-on coating process, and an air gap 132b is formed between the upper surface of the first conversion layer 131 and the flat bottom surface of the second conversion layer 133. The edge of the flat bottom surface of the diffusion layer 135 and the edge of the upper surface of the second conversion layer 133 are attached by print-on coating process, and an air gap 134b is formed between the flat bottom surface of the diffusion layer 135 and the upper surface of the second conversion layer 133. The flat bottom surface of the brightness enhancement layer 137 and the upper surface of the diffusion layer 135 are attached each other with optical cement 136b by the print-on coating without air gap. The upper surface of the brightness enhancement layer 137 is attached or deposited on the bottom surface of the lower polarizer 11b. The first conversion layer 131 converts the point light emitted from the lighting component 14 into linear light and outputs the linear light to the second conversion layer 133. The second conversion layer 133 converts the linear light outputted from the first conversion layer 131 into surface light and outputs the surface light to the diffusion layer 135. The diffusion layer 135 receives and uniforms the surface light outputted from the second conversion layer 133 to make the surface light more uniform. The diffusion layer 135 outputs the uniform surface light to the brightness enhancement layer 137. The brightness enhancement layer 137 receives and enhances the brightness of the surface light outputted from the diffusion layer 135. Next, the brightness enhancement layer 137 outputs the surface light to the lower polarizer 11b, and the lower polarizer 11b polarizes the surface light outputted from the brightness enhancement layer 137. The polarized surface light is outputted to the display panel 12 for displaying images, and the images shown on the display panel 12 is polarized by the upper polarizer 11a.

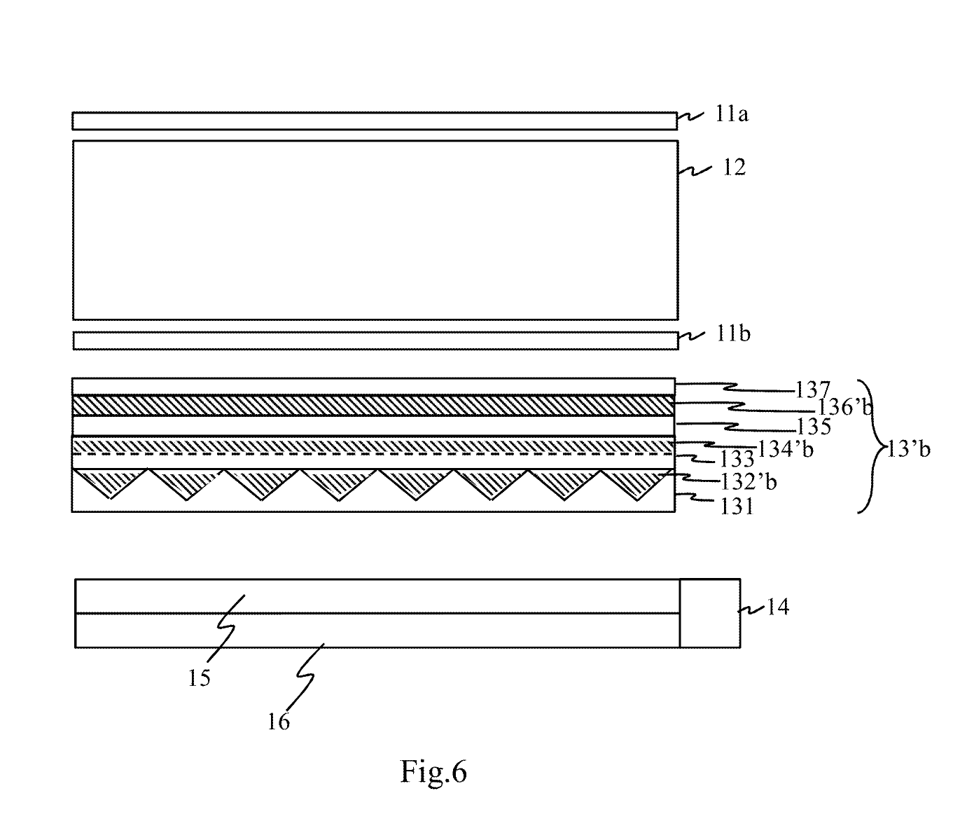

Next, FIG. 6 is a schematically side-view diagram illustrating the fourth embodiment of display module of the present invention.

As shown in FIG. 6. The display module of the present invention includes the upper polarizer 11a, the lower polarizer 11b, the display panel 12, an optically functional film 13′b, the lighting component 14, a light guide plate 15, and a reflection plate 16. The upper polarizer 11a is attached on the upper surface of the display panel 12. The light guide plate 15 is deposited on the reflection plate 16, and the lighting component 14 is set to one side of the light guide plate 15 and one side of the reflection plate 16. The bottom surface of the optically functional film 13′b is attached or deposited on the light guide plate 15, and the upper surface of the optically functional film 13′b is attached or deposited on the bottom surface of the lower polarizer 11b. The upper surface of the lower polarizer 11b is attached on the bottom surface of the display panel 12, and the upper surface of the display panel 12 is attached to the bottom surface of the upper polarizer 11a. The lighting component 14 emits point light to the reflection plate 16, and the reflection plate 16 reflects the point light to the light guide plate 15. The light guide plate 15 guides the propagation direction of the reflected point light and outputs the reflect point light to the optically functional film 13′b. The optically functional film 13′b converts the guide point light into linear light, converts the linear light into surface light, uniforms the surface light, enhances the brightness of the surface light, and outputs the uniform and bright-enhanced surface light to the lower polarizer 11b. The lower polarizer 11b polarizes the surface light and outputs the surface light to the display panel 12. The polarized surface light is outputted to the display panel 12 for displaying images, and the upper polarizer 11a polarizes the images shown by the display panel 12.

Please still refer to FIG. 6. The optically functional film 13′b includes a first conversion layer 131, a second conversion layer 133, a diffusion layer 135 and a brightness enhancement layer 137. The first conversion layer 131 has an upper surface and a bottom surface and the second conversion layer 133 has an upper surface and a bottom surface. The diffusion layer 135 includes a flat upper surface and a flat bottom surface. The brightness enhancement layer 137 has a flat upper surface and a flat bottom surface. The upper surfaces of the first conversion layer 131 and the second conversion layer 133 are both a prism structure (shown in FIG. 3) with a prism angle in the range of 40 to 140 degrees. The upper surface of the first conversion layer 131 and the flat bottom surface of the second conversion layer 133 are attached each other with the optical cement 132′b by print-on coating process without air gap. The flat bottom surface of the diffusion layer 135 and the upper surface of the second conversion layer 133 are attached each other with the optical cement 134′b by print-on coating process without air gap. The bottom surface of the brightness enhancement layer 137 and the upper surface of the diffusion layer 135 are attached each other with the optical cement 136′b by the print-on coating without air gap. The upper surface of the brightness enhancement layer 137 is attached or deposited on the bottom surface of the lower polarizer 11b. The first conversion layer 131 converts the point light emitted from the lighting component 14 into linear light and outputs the linear light to the second conversion layer 133. The second conversion layer 133 converts the linear light outputted from the first conversion layer 131 into surface light and outputs the surface light to the diffusion layer 135. The diffusion layer 135 receives and uniforms the surface light outputted from the second conversion layer 133 to make the surface light more uniform. The diffusion layer 135 outputs the uniform surface light to the brightness enhancement layer 137. The brightness enhancement layer 137 receives and enhances the brightness of the surface light outputted from the diffusion layer 135. Next, the brightness enhancement layer 137 outputs the surface light after enhancing brightness to the lower polarizer 11b, and the lower polarizer 11b polarizes the surface light outputted from the brightness enhancement layer 137. The polarized surface light is outputted to the display panel 12 for displaying images, and the images shown on the display panel 12 is polarized by the upper polarizer 11a.

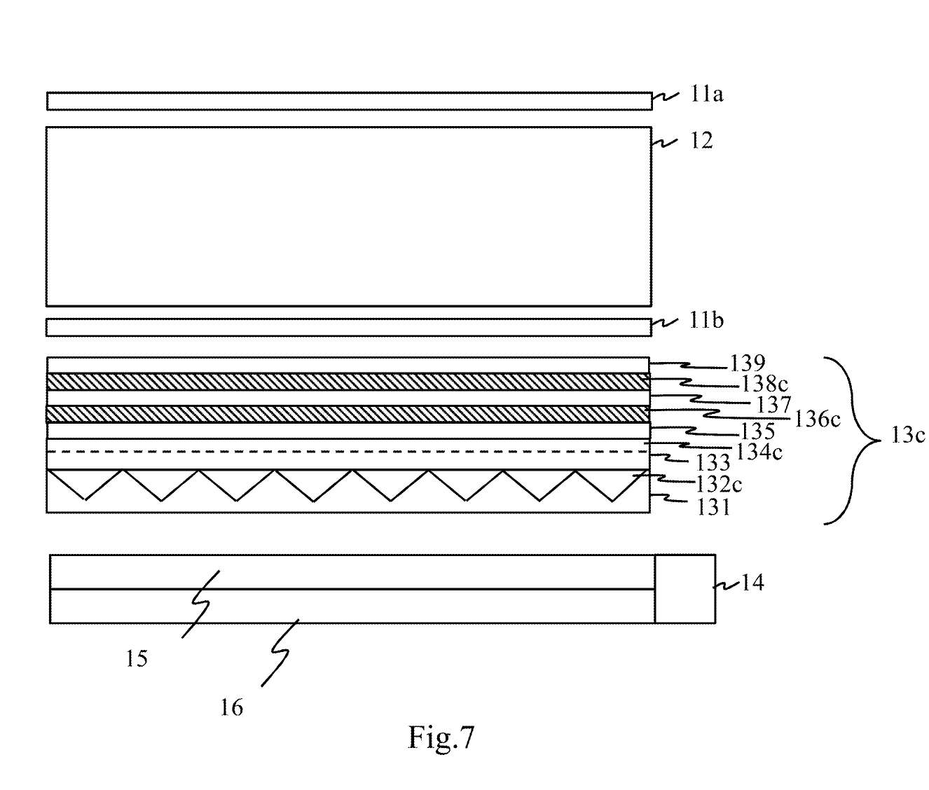

Next, FIG. 7 is a schematically side-view diagram illustrating the fifth embodiment of display module of the present invention.

As shown in FIG. 7, the display module of the present invention includes the upper polarizer 11a, the lower polarizer 11b, the display panel 12, an optically functional film 13c, the lighting component 14, a light guide plate 15, and a reflection plate 16. The light guide plate 15 is deposited on the reflection plate 16, and the lighting component 14 is set to one side of the light guide plate 15 and one side of the reflection plate 16. The bottom surface of the optically functional film 13c is attached or deposited on the light guide plate 15, and the upper surface of the optically functional film 13c is attached or deposited on the bottom surface of the lower polarizer 11b. The upper surface of the lower polarizer 11b is attached on the bottom surface of the display panel 12, and the upper surface of the display panel 12 is attached to the bottom surface of the upper polarizer 11a. The lighting component 14 emits point light to the reflection plate 16, and the reflection plate 16 reflects the point light to the light guide plate 15. The light guide plate 15 guides the propagation direction of the reflected point light and outputs the reflected point light to the optically functional film 13c. The optically functional film 13c converts the guided point light into linear light, converts the linear light into surface light, uniforms the surface light, enhances the brightness of the surface light, and outputs the uniform and bright-enhanced surface light to the lower polarizer 11b. The lower polarizer 11b polarizes the surface light and outputs the surface light to the display panel 12. The polarized surface light is outputted to the display panel 12 for displaying images, and the upper polarizer 11a polarizes the images shown by the display panel 12.

Please still refer to FIG. 7. The optically functional film 13c includes a first conversion layer 131, a second conversion layer 133, a diffusion layer 135, a brightness enhancement layer 137, and a polarization layer 139. The first conversion layer 131 has an upper surface and a bottom surface and the second conversion layer 133 has an upper surface and a bottom surface. The diffusion layer 135 includes a flat upper surface and a flat bottom surface. The brightness enhancement layer 137 has a flat upper surface and a flat bottom surface. The polarization layer 139 has a flat upper surface and a flat bottom surface. The upper surfaces of the first conversion layer 131 and the second conversion layer 133 are both a prism structure (shown in FIG. 3) with a prism angle in the range of 40 to 140 degrees. The edge of the upper surface of the first conversion layer 131 and the edge of the flat bottom surface of the second conversion layer 133 are attached by print-on coating process, and an air gap 132c is formed between the first conversion layer 131 and the second conversion layer 133. The edge of the flat bottom surface of the diffusion layer 135 and the edge of the upper surface of the second conversion layer 133 are attached each other by print-on coating process, and an air gap 134c is formed between the second conversion layer 133 and the diffusion layer 135. The bottom surface of the brightness enhancement layer 137 and the upper surface of the diffusion layer 135 are attached each other with optical cement 136c by the print-on coating without air gap. The bottom surface of the polarization layer 139 and the upper surface of the brightness enhancement layer 137 are attached each other with optical cement 138c by the print-on coating without air gap. The upper surface of the polarization layer 139 is attached or deposited on the bottom surface of the lower polarizer 11b. The first conversion layer 131 converts the point light emitted from the lighting component 14 into linear light and outputs the linear light to the second conversion layer 133. The second conversion layer 133 converts the linear light outputted from the first conversion layer 131 into surface light and outputs the surface light to the diffusion layer 135. The diffusion layer 135 receives and uniforms the surface light outputted from the second conversion layer 133 to make the surface light more uniform. The brightness enhancement layer 137 receives and enhances the brightness of the surface light outputted from the diffusion layer 135. Next, the polarization layer 139 receives the brightness-enhancing surface light outputted from the brightness enhancement layer 137 and converts the brightness-enhanced surface light into polarized light. The polarization layer 139 outputs the surface light to the lower polarizer 11b, and the lower polarizer 11b polarizes the surface light. The polarized surface light is outputted to the display panel 12 for displaying images, and the images shown on the display panel 12 is polarized by the upper polarizer 11a.

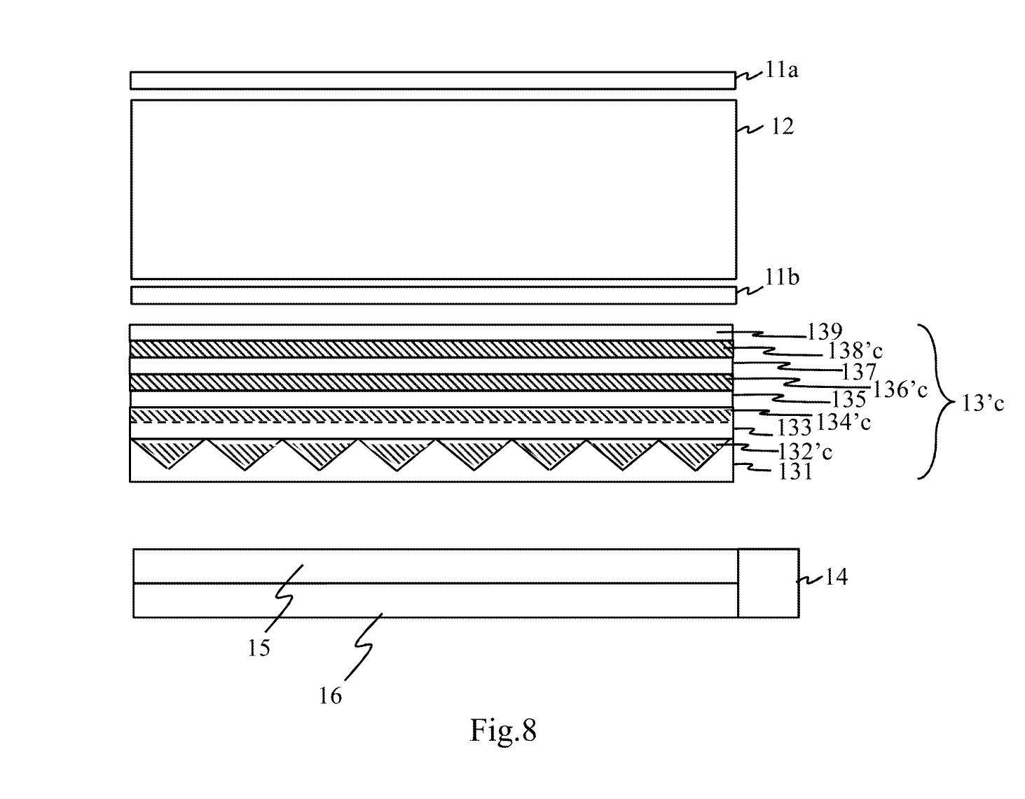

Next, FIG. 8 is a schematically side-view diagram illustrating the sixth embodiment of display module of the present invention.

As shown in FIG. 8, the display module of the present invention includes the upper polarizer 11a, the lower polarizer 11b, the display panel 12, an optically functional film 13′c, the lighting component 14, a light guide plate 15, and a reflection plate 16. The upper polarizer 11a is attached to the upper surface of the display panel 12. The light guide plate 15 is deposited on the reflection plate 16, and the lighting component 14 is set to one side of the light guide plate 15 and one side of the reflection plate 16. The bottom surface of the optically functional film 13′c is attached or deposited on the light guide plate 15, and the upper surface of the optically functional film 13′c is attached or deposited on the bottom surface of the lower polarizer 11b. The upper surface of the lower polarizer 11b is attached to the bottom surface of the display panel 12. The lighting component 14 emits point light to the reflection plate 16, and the reflection plate 16 reflects the point light to the light guide plate 15. The light guide plate 15 guides the propagation direction of the reflected point light and outputs the reflected point light to the optically functional film 13′c. The optically functional film 13′c converts the guided point light into linear light, converts the linear light into surface light, uniforms the surface light, enhances the brightness of the surface light, and outputs the uniform and bright-enhanced surface light to the lower polarizer 11b. The lower polarizer 11b polarizes the surface light and outputs surface light to the display panel 12. The polarized surface light is outputted to the display panel 12 for displaying images, and the upper polarizer 11a polarizes the images shown by the display panel 12.

Please still refer to FIG. 8. The optically functional film 13′c includes a first conversion layer 131, a second conversion layer 133, a diffusion layer 135, a brightness enhancement layer 137, and a polarization layer 139. The first conversion layer 131 has an upper surface and a bottom surface and the second conversion layer 133 has an upper surface and a bottom surface. The diffusion layer 135 includes a flat upper surface and a flat bottom surface. The brightness enhancement layer 137 has a flat upper surface and a flat bottom surface. The polarization layer 139 has a flat upper surface and a flat bottom surface. The upper surfaces of the first conversion layer 131 and the second conversion layer 133 are both a prism structure (shown in FIG. 3) with a prism angle in the range of 40 to 140 degrees. The upper surface of the first conversion layer 131 and the flat bottom surface of the second conversion layer 133 are attached each other with optical cement 132′c of by print-on coating process without air gap. The flat bottom surface of the diffusion layer 135 and the upper surface of the second conversion layer 133 are attached each other with optical cement 134′c by print-on coating process without air gap. The bottom surface of the brightness enhancement layer 137 and the upper surface of the diffusion layer 135 are attached each other with optical cement 136′c by the print-on coating without air gap. The bottom surface of the polarization layer 139 and the upper surface of the brightness enhancement layer 137 are attached each other with optical cement 138′c by the print-on coating without air gap. The upper surface of the polarization layer 139 is attached or deposited on the bottom surface of the lower polarizer 11b. The first conversion layer 131 converts the point light emitted from the lighting component 14 into linear light and outputs the linear light to the second conversion layer 133. The second conversion layer 133 converts the linear light outputted from the first conversion layer 131 into surface light and outputs the surface light to the diffusion layer 135. The diffusion layer 135 receives and uniforms the surface light outputted from the second conversion layer 133 to make the surface light more uniform. The brightness enhancement layer 137 receives and enhances the brightness of the surface light outputted from the diffusion layer 135. Next, the polarization layer 139 receives the brightness-enhanced surface light outputted from the brightness enhancement layer 137 and converts the brightness-enhanced surface light into polarized light. The polarization layer 139 outputs the surface light to the lower polarizer 11b, and the lower polarizer 11b polarizes the surface light. The polarized surface light is outputted to the display panel 12 for displaying images, and the images shown on the display panel 12 is polarized by the upper polarizer 11a.

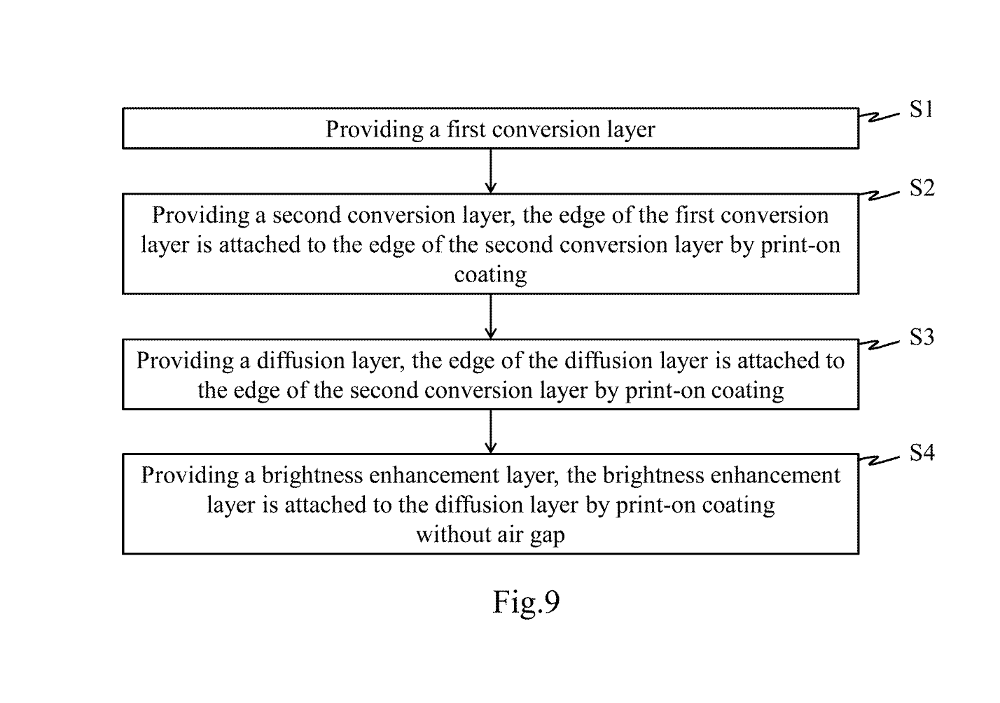

Next, FIG. 2 is a schematically side-view diagram illustrating the first embodiment of display module of the present invention. FIG. 9 is a schematically diagram illustrating manufacturing steps of an optically functional film in the first and the third embodiment of the present invention.

Please refer to FIG. 2 and FIG. 9. First, in step S1, providing the first conversion layer 131 including the upper surface and the bottom surface may convert the point light source into the linear light source. The upper surface of the first conversion layer 131 is a prism structure with a prism angle in the range of 40 to 140 degrees (shown in FIG. 3), and the bottom surface of the first conversion layer 131 is a flat surface. Next, in step S2, providing the second conversion layer 133 which has the upper surface of prism structure (shown in FIG. 3) in the range of 40 to 140 degrees, and the flat bottom surface. The edge of the upper surface of the first conversion layer 131 and the edge of the flat bottom surface of the second conversion layer 133 are attached by print-on coating process, and the air gap 132a is formed between the upper surface of the first conversion layer 131 and the flat bottom surface of the second conversion layer 133. The second conversion layer 133 converts linear light into surface light. Next, in step S3, providing the diffusion layer 135 which includes the flat upper surface and the flat bottom surface. The edge of the flat bottom surface of the diffusion layer 135 and the edge of the upper surface of the second conversion layer 133 are attached by print-on coating process, and an air gap 134a is formed between the flat bottom surface of the diffusion layer 135 and the upper surface of the second conversion layer 133. The first conversion layer 131, the second conversion layer 133, and the diffusion layer 135 are combined to form the optically functional film 13a.

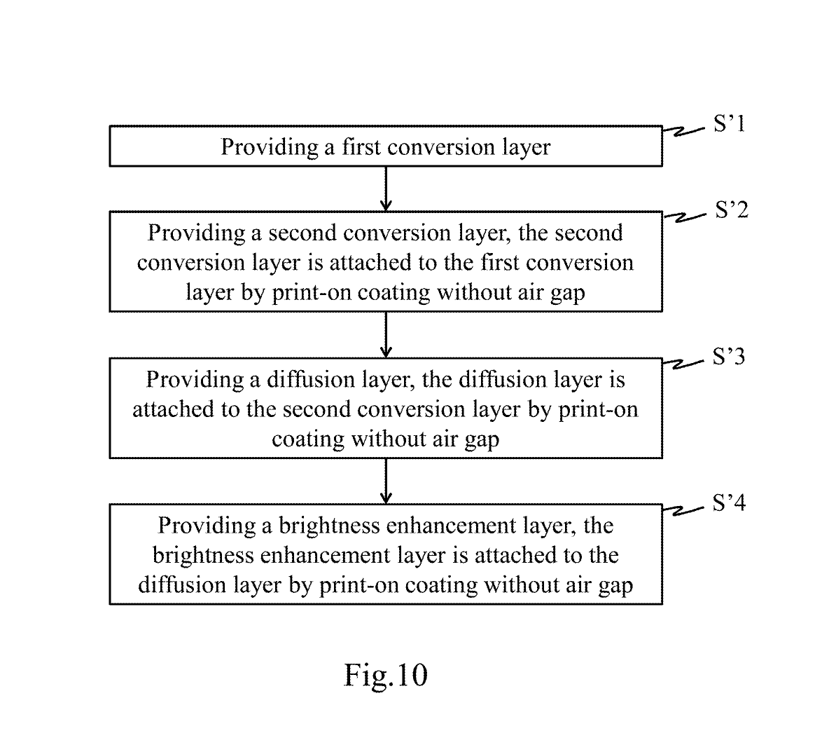

Next, FIG. 4 is a schematically side-view diagram illustrating the second embodiment of display module of the present invention. FIG. 10 is a schematically diagram illustrating manufacturing steps of an optically functional film in the second and the fourth embodiment of the present invention.

Please refer to FIG. 4 and FIG. 10. First, in step S′1, the first conversion layer 131 is provided. The upper surface of the first conversion layer 131 is a prism structure with a prism angle in the range of 40 to 140 degrees (shown in FIG. 3), and the bottom surface of the first conversion layer 131 is a flat surface. The first conversion layer 131 may convert the point light source into the linear light source. Next, in step S′2, providing the second conversion layer 133 which has the upper surface of prism structure (shown in FIG. 3) in the range of 40 to 140 degrees, and the flat bottom surface. The upper surface of the first conversion layer 131 and the flat bottom surface of the second conversion layer 133 are attached each other with the optical cement 132′a by print-on coating process without air gap. The second conversion layer 133 converts linear light into surface light. Next, in step S′3, the diffusion layer 135 is provided. The flat bottom surface of the diffusion layer 135 and the upper surface of the second conversion layer 133 are attached each other with the optical cement 134′a by print-on coating process without air gap. The first conversion layer 131, the second conversion layer 133, and the diffusion layer 135 are combined to form the optically functional film 13′a.

Next, FIG. 5 is a schematically side-view diagram illustrating the third embodiment of display module of the present invention. FIG. 9 is a schematically diagram illustrating manufacturing steps of an optically functional film in the first and the third embodiment of the present invention.

Please refer to FIG. 5 and FIG. 9. First, in step S1, providing the first conversion layer 131 including the upper surface and the bottom surface may convert the point light into the linear light. The upper surface of the first conversion layer 131 is a prism structure with a prism angle in the range of 40 to 140 degrees (shown in FIG. 3). The bottom surface of the first conversion layer 131 is a flat surface. Next, in step S2, providing the second conversion layer 133 which has the upper surface of prism structure (shown in FIG. 3) in the range of 40 to 140 degrees, and the flat bottom surface. The edge of the upper surface of the first conversion layer 131 and the edge of the flat bottom surface of the second conversion layer 133 are attached by print-on coating process, and the air gap 132b is formed between the upper surface of the first conversion layer 131 and the flat bottom surface of the second conversion layer 133. The second conversion layer 133 converts linear light into surface light. Next, in step S3, providing the diffusion layer 135 which includes the flat upper surface and the flat bottom surface. The edge of the flat bottom surface of the diffusion layer 135 and the edge of the upper surface of the second conversion layer 133 are attached by print-on coating process, and an air gap 134b is formed between the flat bottom surface of the diffusion layer 135 and the upper surface of the second conversion layer 133. Finally, in step S4, providing the brightness enhancement layer 137 which has the flat upper surface and the flat bottom surface. The bottom surface of the brightness enhancement layer 137 and the upper surface of the diffusion layer 135 are attached each other with the optical cement 136b by print-on coating process without air gap. The first conversion layer 131, the second conversion layer 133, the diffusion layer 135, and the brightness enhancement layer 137 are combined to form the optically functional film 13b.

Next, FIG. 6 is a schematically side-view diagram illustrating the fourth embodiment of display module of the present invention. FIG. 10 is a schematically diagram illustrating manufacturing steps of an optically functional film in the second and the fourth embodiment of the present invention.

Please refer to FIG. 6 and FIG. 10. First, in step S′1, providing the first conversion layer 131 which includes the upper surface and the bottom surface. The upper surface of the first conversion layer 131 is a prism structure with a prism angle in the range of 40 to 140 degrees (shown in FIG. 3), and the bottom surface of the first conversion layer 131 is a flat surface. The first conversion layer 131 may convert the point light source into the linear light source. Next, in step S′2, providing the second conversion layer 133 which has the upper surface of prism structure (shown in FIG. 3) in the range of 40 to 140 degrees, and the flat bottom surface. The upper surface of the first conversion layer 131 and the flat bottom surface of the second conversion layer 133 are attached each other with the optical cement 132′b by print-on coating process without air gap. The second conversion layer 133 converts linear light into surface light. Next, in step S′3, the diffusion layer 135 is provided. The flat bottom surface of the diffusion layer 135 and the upper surface of the second conversion layer 133 are attached each other with the optical cement 134′b by print-on coating process without air gap. Finally, in step S′4, providing the brightness enhancement layer 137 which has the flat upper surface and the flat bottom surface. The bottom surface of the brightness enhancement layer 137 and the upper surface of the diffusion layer 135 are attached with the optical cement 136′b by print-on coating process without air gap. The first conversion layer 131, the second conversion layer 133, the diffusion layer 135, and the brightness enhancement layer 137 are combined to form the optically functional film 13′b.

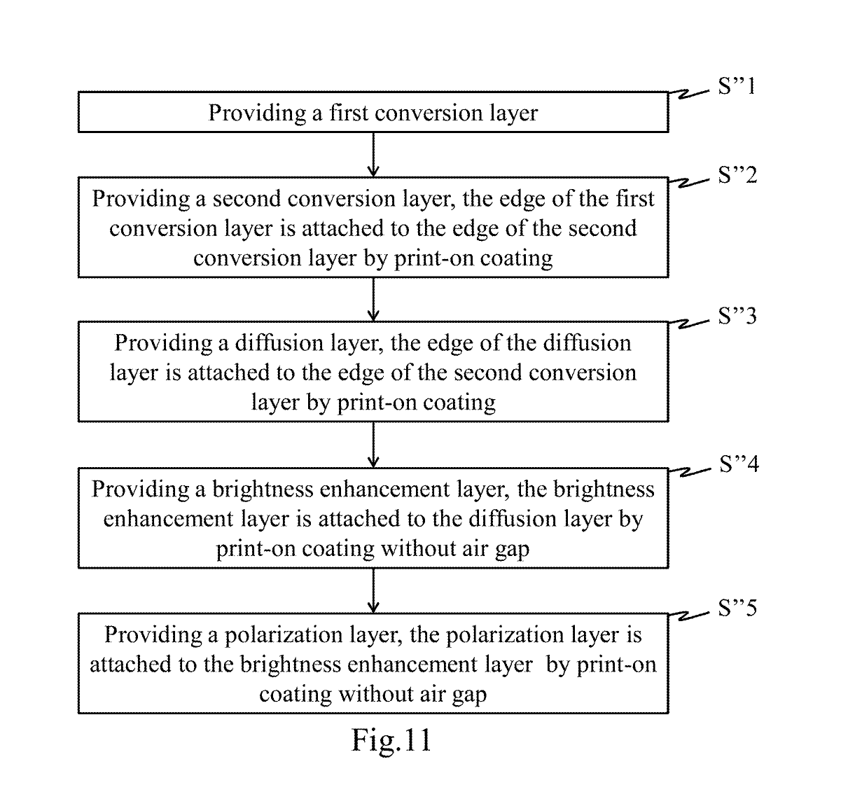

Next, FIG. 7 is a schematically side-view diagram illustrating the fifth embodiment of display module of the present invention. FIG. 11 is a schematically diagram illustrating manufacturing steps of an optically functional film in the fifth embodiment according to the present invention.

Please refer to FIG. 7 and FIG. 11. First, in Step S″1, providing the first conversion layer 131 including the upper surface and the bottom surface may convert the point light into the linear light. The upper surface of the first conversion layer 131 is a prism structure with a prism angle in the range of 40 to 140 degrees (shown in FIG. 3). The bottom surface of the first conversion layer 131 is a flat surface. Next, in step S″2, providing the second conversion layer 133 which has the upper surface of prism structure (shown in FIG. 3) in the range of 40 to 140 degrees, and the flat bottom surface. The edge of the upper surface of the first conversion layer 131 and the edge of the flat bottom surface of the second conversion layer 133 are attached each other by print-on coating process, and the air gap 132c is formed between the upper surface of the first conversion layer 131 and the flat bottom surface of the second conversion layer 133. The second conversion layer 133 converts the linear light into the surface light. Next, in step S″3, providing the diffusion layer 135 which includes the flat upper surface and the flat bottom surface. The edge of the flat bottom surface of the diffusion layer 135 and the edge of the upper surface of the second conversion layer 133 are attached each other by print-on coating process, and an air gap 134c is formed between the flat bottom surface of the diffusion layer 135 and the upper surface of the second conversion layer 133. Next, in step S″4, providing the brightness enhancement layer 137 which has the flat upper surface and the flat bottom surface. The bottom surface of the brightness enhancement layer 137 and the upper surface of the diffusion layer 135 are attached with the optical cement 136c by print-on coating process without air gap. Finally, in step S″5, providing the polarization layer 139 which has the flat upper and bottom surfaces. The bottom surface of the polarization layer 139 and the upper surface of the brightness enhancement layer 137 are attached with the optical cement 138c by print-on coating process without air gap. The first conversion layer 131, the second conversion layer 133, the diffusion layer 135, the brightness enhancement layer 137, and the polarization layer 139 are combined to form the optically functional film 13c.

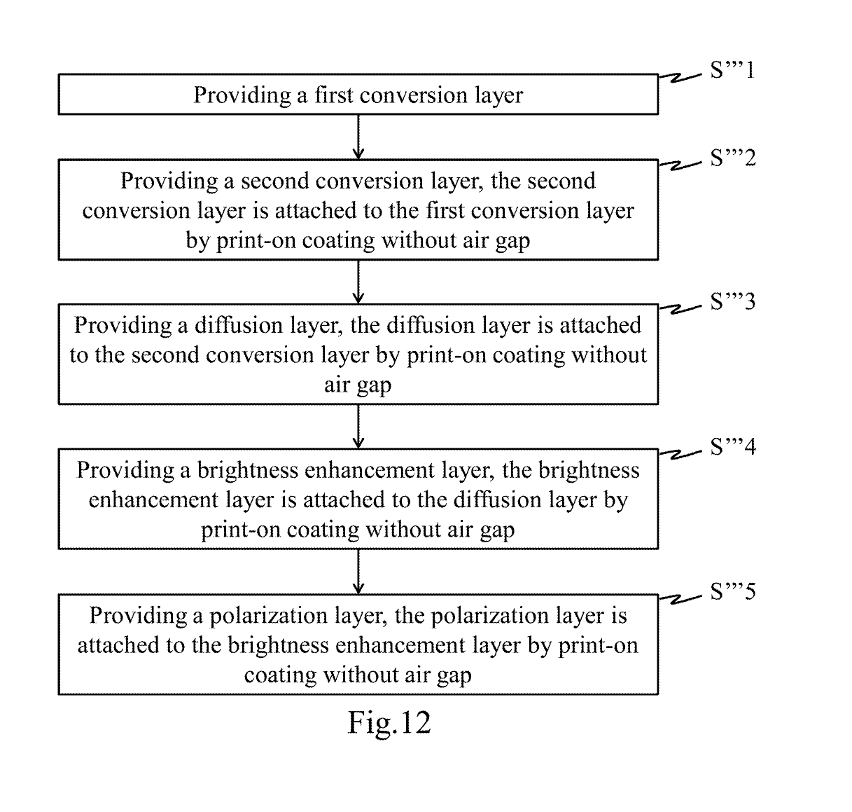

Next, FIG. 8 is a schematically side-view diagram illustrating the sixth embodiment of display module of the present invention. FIG. 12 is a schematically diagram illustrating manufacturing steps of an optically functional film in the sixth embodiment of the present invention.

Please refer to FIG. 8 and FIG. 12. First, in step S′″1, providing the first conversion layer 131 including the upper surface and the bottom surface may convert the point light into the linear light. The upper surface of the first conversion layer 131 is a prism structure with a prism angle in the range of 40 to 140 degrees (shown in FIG. 3), and the bottom surface of the first conversion layer 131 is a flat surface. Next, in step S′″2, providing the second conversion layer 133 which has the upper surface of prism structure (shown in FIG. 3) in the range of 40 to 140 degrees, and the flat bottom surface. The upper surface of the first conversion layer 131 and the flat bottom surface of the second conversion layer 133 are attached each other with the optical cement 132′c by print-on coating process without air gap. The second conversion layer 133 converts linear light into surface light. Next, in step S′″3, providing the diffusion layer 135 which includes the flat upper surface and the flat bottom surface. The flat bottom surface of the diffusion layer 135 and the upper surface of the second conversion layer 133 are attached each other with the optical cement 134′c by print-on coating process without air gap. Next, in step S′″4, providing the brightness enhancement layer 137 which has the flat upper surface and the flat bottom surface. The bottom surface of the brightness enhancement layer 137 and the upper surface of the diffusion layer 135 are attached with the optical cement 136′c by print-on coating process without air gap. Finally, in step S′″5, providing the polarization layer 139 which has the flat upper and bottom surfaces. The bottom surface of the polarization layer 139 and the upper surface of the brightness enhancement layer 137 are attached with the optical cement 138′c by print-on coating process without air gap. The first conversion layer 131, the second conversion layer 133, the diffusion layer 135, the brightness enhancement layer 137, and the polarization layer 139 are combined to form the optically functional film 13′ c.

In these embodiments aforementioned, the materials of the first conversion layer 131 and the second conversion layer 133 are high molecular polymer, such as resin, acrylics, and so on, but not limited in the present invention.

In these embodiments aforementioned, the optical cements 132′a, 134′a, 136b, 132′b, 134′b, 136′b, 136c, 138c, 132′c, 134′c, 136′c, or 138′c is a cement of matching index of refraction. For example, the optical cement 132′a, the optical cement 132′b, and the optical cement 132′c between the first conversion layer 131 and the second conversion layer 133 have the index of refraction about 1.35-1.48, respectively; the optical cement 134′a, the optical cement 134′b, and the optical cement 134′c between the second conversion layer 133 and the diffusion layer 135 have the index of refraction about 1.35-1.48, respectively. The optical cement 138c and the optical cement 138′c between the brightness enhancement layer 137 and the polarization layer 139 have the index of refraction about 1.48-1.52, respectively. The optical cement 136b, the optical cement 136′b, the optical cement 136c, and the optical cement 136′c between the diffusion layer 135 and the brightness enhancement layer 137 have the index of refraction about 1.48-1.52, respectively. By the matching of the indices of refraction, there are tightly attachments between the first conversion layer 131 and the second conversion layer 133, between the brightness enhancement layer 137 and the polarization layer 139, between the diffusion layer 135 and the second conversion layer 133, as well as between the diffusion layer 135 and the brightness enhancement layer 137. By the print-on coating process, the first conversion layer 131, the second conversion layer 133, the diffusion layer 135, the brightness enhancement layer 137, and the polarization layer 139 of the optically functional film 13, the optically functional film 13a, the optically functional film 13′a, the optically functional film 13b, the optically functional film 13′b, the optically functional film 13c, and the optically functional film 13′c, respectively, can be combined into a piece for reducing the thicknesses of the optically functional film 13, the optically functional film 13a, the optically functional film 13′a, the optically functional film 13b, the optically functional film 13′b, the optically functional film 13c, and the optically functional film 13′c, respectively. Moreover, the whole volume of the display module can be reduced the amount of 50%-60%, without lowering the brightness of the display module. In these embodiments aforementioned, the whole thickness of the optically functional film 13c or the optically functional film 13′c including the polarization layer 139 is about 0.6 mm to 1.4 mm. The whole thickness of the optically functional film 13a, the optically functional film 13′a, the optically functional film 13b, or the optically functional film 13′b, which does not include the polarization layer 139 is about 0.4 mm to 1.2 mm.

In these embodiments aforementioned, an air gap may be formed between the first conversion layer 131 and the second conversion layer 133 of the optically functional film 13a, optically functional film 13b, or optically functional film 13c, as well as between the second conversion layer 133 and the diffusion layer 135 by the print-on coating process. The formation of the air gap may reduce problems of thermal expansion and contraction and enhance the reliability of the display module, without influences on display brightness or contrast.

In these embodiments aforementioned, the upper polarizer 11a, the lower polarizer 11b, or the polarization layer 139 may be an optical component capable of polarizing, such as linear polarizer, elliptic polarizer, or circuit polarizer, but not limited to in the present invention.

In these embodiments aforementioned, the display panel 12 may be a liquid crystal panel, and the display module may be a liquid crystal display or a light emitting diode display. Moreover, the display may include a portable display, a desktop display or a vehicle display. The portable display may be one of a mobile phone, a camera, and a panel computer. The desktop display may be one of a television, a desktop computer, and a laptop computer. The vehicle display may be the one of a satellite navigator, an automobile instrument panel, and a data recorder, but not limited to. The lighting component 14 may be a light emitting diode (LED), a cold cathode fluorescent lamp (CCFL), or electro luminescent (EL), but not limited to.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A display module with an optically functional film, which includes an upper polarizer, a lower polarizer, a display panel, a lighting component, a light guide plate, and a reflection plate, in which the upper polarizer and the lower polarizer are respectively attached to an upper surface and a bottom surface of the display panel, and the light guide plate is deposited on the reflection plate, the lighting component is set to one side of the light guide plate and one side of the reflection plate, the lighting component emits a point light to the reflection plate, and the reflection plate reflects the point light to the light guide plate, and the light guide plate guides the propagation direction of the point light, wherein the display module with the optically functional film is characterized in:
a bottom surface of the optically functional film is deposited on the light guide plate, an upper surface of the optically functional film is deposited on a bottom surface of the lower polarizer and receives the guided point light outputted from the light guide plate, and a thickness of the optically functional film is from 0.4 mm to 1.4 mm; and
the optically functional film comprises a first conversion layer, a second conversion layer and a diffusion layer, wherein:
the first conversion layer comprises an upper surface of a prism structure and a flat bottom surface, the first conversion layer converts the guided point light outputted from the light guide plate into a linear light and outputs the linear light to the second conversion layer, the second conversion layer comprises an upper surface of a prism structure and a flat bottom surface, the second conversion layer is deposited on the first conversion layer, the second conversion layer converts the linear light outputted from the first conversion layer into surface light and outputs the surface light to the diffusion layer, and the diffusion layer comprises a flat upper surface and a flat bottom surface, the diffusion layer is deposited on the second conversion layer, and the diffusion layer uniforms the surface light outputted from the second conversion layer.

2. The display module with an optically functional film of claim 1, wherein the edge of the upper surface of the first conversion layer and the edge of the flat bottom surface of the second conversion layer are attached each other, an air gap is formed between the upper surface of the first conversion layer and the bottom surface of the second conversion layer, the flat bottom surface of the diffusion layer and the upper surface of the second conversion layer are attached each other with their respective edges, and an air gap is formed between the bottom surface of the diffusion layer and the upper surface of the second conversion layer.

3. The display module with an optically functional film of claim 2, wherein the optically functional film further comprises a brightness enhancement layer, the brightness enhancement layer comprises a flat upper surface and a flat bottom surface, and the flat bottom surface of the brightness enhancement layer and the flat upper surface of the diffusion layer are attached each other with a first optical cement.

4. The display module with an optically functional film of claim 3, wherein the optically functional film further comprises a polarization layer, the polarization layer comprises a flat upper surface and a flat bottom surface, and the flat bottom surface of the polarization layer and the flat upper surface of the brightness enhancement layer are attached each other with a second optical cement.

5. The display module with an optically functional film of claim 1, wherein the upper surface of the first conversion layer and the bottom surface of the second conversion layer are attached each other with a third optical cement, and no air gap is formed between the upper surface of the first conversion layer and the bottom surface of the second conversion layer, and the flat bottom surface of the diffusion layer and the upper surface of the second conversion layer are attached each other with a fourth cement, and no air gap is formed between the flat bottom surface of the diffusion layer and the upper surface of the second conversion layer.

6. The display module with an optically functional film of claim 5, wherein the optically functional film further comprises a brightness enhancement layer, the brightness enhancement layer comprises a flat upper surface and a flat bottom surface, and the flat bottom surface of the brightness enhancement layer and the flat upper surface of the diffusion layer are attached each other with a fifth optical cement.

7. The display module with an optically functional film of claim 6, wherein the optically functional film further comprises a polarization layer, the polarization layer comprises a flat upper surface and a flat bottom surface, and the flat bottom surface of the polarization layer and the flat upper surface of the brightness enhancement layer are attached each other with a sixth optical cement, and the upper surface of the polarization layer is deposited on the bottom surface of the lower polarizer.

8. The display module with an optically functional film of claim 3, wherein the first optical cement is a cement of matching index of refraction.

9. The display module with an optically functional film of claim 4, wherein the second optical cement is a cement of matching index of refraction.

10. The display module with an optically functional film of claim 5, wherein third optical cement and the fourth optical cement are a cement of matching index of refraction.

11. The display module with an optically functional film of claim 6, wherein the fifth optical cement is a cement of matching index of refraction.

12. The display module with an optically functional film of claim 7, wherein the sixth optical cement is a cement of matching index of refraction.

13. A manufacturing method of an optically functional film, in which a bottom surface of the optically functional film is deposited on a light guide plate of a display module, an upper surface of the optically functional film is deposited on a bottom surface of a lower polarizer of the display module, the manufacturing method of the optically functional film comprising:
providing a first conversion layer having an upper surface of a prism structure with a prism angle in the range of 40 to 140 degrees and a flat bottom surface, and the first conversion layer converts a point light into a linear light;
providing a second conversion layer having an upper surface of a prism structure and a flat bottom surface, and the second conversion layer converts the linear light outputted from the first conversion layer into a surface light;
depositing the second conversion layer on the first conversion layer by print-on coating process, the edge of the upper surface of the first conversion layer and the edge of the bottom surface of the second conversion layer being attached each other, and an air gap being formed between the upper surface of the first conversion layer and the bottom surface of the second conversion layer;
providing a diffusion layer having a flat upper surface and a flat bottom surface, and the diffusion layer uniforms the surface light outputted from the second conversion layer; and
depositing the diffusion layer onto the second conversion layer by print-on coating process, the edge of the upper surface of the second conversion layer and the edge of the bottom surface of the diffusion layer being attached each other, and an air gap being formed between the upper surface of the second conversion layer and the bottom surface of the diffusion layer.

14. The manufacturing method of an optically functional film of claim 13, further comprising:
providing a brightness enhancement layer having a flat upper surface and a flat bottom surface; and
depositing the bottom surface of the brightness enhancement layer onto the upper surface of the diffusion layer by print-on coating process, and the bottom surface of the brightness enhancement layer and the upper surface of the diffusion layer being attached each other with an optical cement without air gap.

15. The manufacturing method of an optically functional film of claim 14, further comprising:
providing a polarization layer having a flat upper surface and a flat bottom surface; and
attaching the flat bottom surface of the polarization layer and the upper surface of the brightness enhancement layer each other with an optical cement without air gap.

16. The manufacturing method of an optically functional film of claim 13, further comprising filling a first optical cement into the air gap between the first conversion layer and the second conversion layer, and filling a second optical cement into the air gap between the second conversion layer and the diffusion layer.

17. The manufacturing method of an optically functional film of claim 16, further comprising:
providing a brightness enhancement layer having a flat upper surface and a flat bottom surface; and
depositing the flat bottom surface of the brightness enhancement layer onto the flat upper surface of the diffusion layer by print-on coating process, and the flat bottom surface of the brightness enhancement layer and the flat upper surface of the diffusion layer being attached each other with an optical cement without air gap.

18. The manufacturing method of an optically functional film of claim 17, further comprising:
providing a polarization layer having a flat upper surface and a flat bottom surface; and
attaching the flat bottom surface of the polarization layer and the flat upper surface of the brightness enhancement layer each other with an optical cement of without gap.
